(19) United States
(12) Patent Application Publication
(10) Pub. No.: US 2008/0232620 A1
(43) Pub. Date: Sep. 25, 2008

(54) Processor system with directly interconnected ports

(75) Inventor: Thomas Dickel, Buttenheim (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GmbH

(21) Appl. No.: 12/077,611

(22) Filed: Mar. 20, 2008

(30) Foreign Application Priority Data
Mar. 23, 2007 (DE) 10 2007 014 132.9

(51) Int. Cl. H04R 25/00

(52) U.S. Cl. 381/313

(57) ABSTRACT

The current consumption of a processor system in particular for hearing devices is to be reduced. To this end, a processor system with a first processor, which has at least one output and at least one second processor, which has at least one input is provided. The output of the first processor can be directly connected to the input of the second processor using a switching facility. The direct connection of the output and input of the processors obviates the need for computing power for the communication between the processors, thereby resulting in a considerable saving of current.

### CROSS REFERENCE TO RELATED APPLICATIONS

This application claims priority of German application No. 10 2007 014 132.9 DE filed Mar. 23, 2007, which is incorporated by reference herein in its entirety.

### FIELD OF INVENTION

The present invention relates to a processor system for a hearing apparatus with a first processor, which has at least one output, and at least one second processor, which has at least one input. The term “hearing apparatus” is understood here to mean in particular any device which can be worn on the ear, e.g. a hearing device, a headset, earphones and suchlike.

### BACKGROUND OF INVENTION

Hearing devices are portable hearing apparatuses which are used to supply the hard-of-hearing. To accommodate the numerous individual requirements, different configurations of hearing devices such as behind-the-ear hearing devices (BTE), in-the-ear hearing devices (ITE), e.g. including concha hearing devices or channel hearing devices (CIC), are provided. The hearing devices detailed by way of example are worn on the outer ear or in the auditory canal. Furthermore, bone conduction hearing aids, implantable or vibrotactile hearing aids are also available on the market. In such cases the damaged hearing is stimulated either mechanically or electrically.

Essential components of the hearing devices include in principle an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This basic configuration is shown in the example in FIG. 1 of a behind-the-ear hearing device. One or a number of microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is provided by a battery 5 which is likewise integrated into the hearing device housing 1.

### SUMMARY OF INVENTION

Digital signal processors (DSP) are being increasingly used in modern hearing devices. As a result, the complexity of the system is to be reduced and the flexibility increased. This makes it possible to implement efficient algorithms on the DSP. In this way however, the limits of the admissible current consumption are reached quickly. This applies in particular to the processing of time domain signals. As, during the processing of this signal, the computation frame, i.e. the subprogram for each individual sample repeats with the sample frequency of the signal, variables from the memory are to be repeated each time and restored following computation. Memory accesses of this type (move commands) may consume a large part of the available processor power and thus increase the current consumption considerably.

Numerous possibilities exist for counteracting this problem. All approaches are however associated with disadvantages. In the case of a block processing for instance, a number of samples can be very effectively calculated directly one after the other in a frame. The disadvantage here is however that this results in increased processing times, since the samples firstly have to be collected and a period of time must subsequently elapse until the desired number of samples is in the memory.

Another possibility for reducing the processing power consists in the parallel processing with a number of computing units in a DSP, e.g. a number of multiply and accumulate units (MAC units). The disadvantage here is however that this parallel processing is only suited to regular algorithms. I.e. only algorithms in which a number of steps always run at the same time, can profit from the parallel processing, whereas control functions require numerous individual calculations for instance, which can not be executed in parallel, since in principle a processor only has one program control tool (control).

Further possibilities for increasing the processing power consist in increasing the processor clock or in the use of a number of processors. However, the disadvantage here is again that the current consumption increases proportionally to the processor clock and/or number of processors. Furthermore, with several processors, the memory accesses for communication with each other put pressure on their performance and thus the current budget. However, several specialized and therewith low-current processors may be used with a reduced command record, however the memory accesses for communication with each other put pressure on the performance and current budget.

The publication EP 1 841 284 A1 discloses a hearing instrument for storing encoded audio data. A digital signal processor and further elements of the hearing instrument are controlled by a microprocessor. The microprocessor receives encoded audio data from a memory and transmits this to the digital signal processor with the aid of a double buffer.

The publication DE 195 04 089 A1 also discloses a so-called “Pipelined SIMD-Systolic Array-Processor”. The inputs and outputs of processor elements are directly connected to one another by way of multiplexers.

The object of the present invention thus consists in proposing a processor system for hearing apparatuses, the current consumption of which is reduced further.

This object is achieved in accordance with the invention by a processor system for a hearing apparatus with a first processor, which has at least one output, and at least one second processor, which has at least one input, as well as switching facility, with which the output of the first processor can be directly connected to the input of the second processor. The term processor is understood here to mean a hardware computing unit for controlling a device or a component thereof by way of software.

Advantageously, no computing power needs to be expended for the communication between the processors as a result of the processors being directly connected to one another by means of the switching facility. This saves on a considerable amount of current consumption.

Each of the processors preferably has several inputs and outputs and the switching facility has a separate switch for direct connection with one another for each input-output combination. A switching network is herewith provided, with which the inputs and outputs of the processors can be flexibly connected to one another.

It is also advantageous if the switching facility is embodied in the manner of a matrix and is arranged at each node point per switch. A linking of inputs and outputs of the processors is thus possible in a very clearly arranged manner.

The switching facility can also have a configuration memory, in which switching information is stored, which is used to control the switch. This increases the flexibility of the switching facility and thus that of the processor system, since different switching configurations can be achieved without any problem with the aid of software.

The output of the first processor can comprise an output register, while the input of the second processor is formed without a register. The same applies to all other inputs and outputs of the processors. It is namely sufficient to provide the respective information in the respective output register, so that any input line has access thereto.

The processor system according to the invention is particularly preferably used in a hearing device, since the saving of current there is continuously a paramount aim with high processor power.

### BRIEF DESCRIPTION OF THE DRAWINGS

The present invention is described in more detail with reference to the appended drawings, in which;

FIG. 1 shows the basic design of a hearing device according to the prior art;

FIG. 2 shows a multi-processor system with processor communication according to the prior art and

FIG. 3 shows a multi-processor system with a switching network according to the present invention.

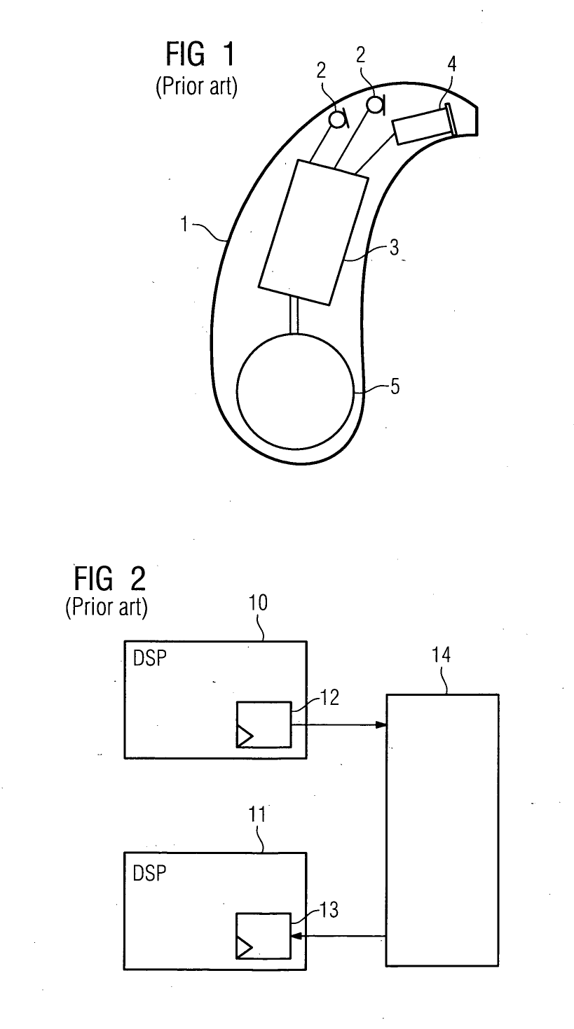

### DETAILED DESCRIPTION OF INVENTION

The exemplary embodiment illustrated in more detail below represents a preferred embodiment of the present invention. A brief explanation as to how the communication takes place between two processors according to the prior art is however first made on the basis of FIG. 2, in order to be able to better understand the present invention.

FIG. 2 shows two processors 10 and 11. Each one has a register 12, 13. If the data is to be transmitted from DSP 10 to DSP 11, a memory 14 is usually interconnected therebetween. The data transmission is then carried out in a first step from an output register 12 of the DSP 10 into the memory 14. To this end, an addressing and special memory control signals are necessary. In a second step, the data from the memory 14 is loaded into an input register 13 of the DSP 11. This also requires an addressing and memory control signals. The processors 10, 11 usually communicate with direct memory access (DMA) by way of shared memory addresses (shared memory). Memory accesses of this type nevertheless put pressure on the system in terms of its performance and current consumption. The consumption of as little energy as possible for the signal processing nevertheless applies to hearing devices for instance.

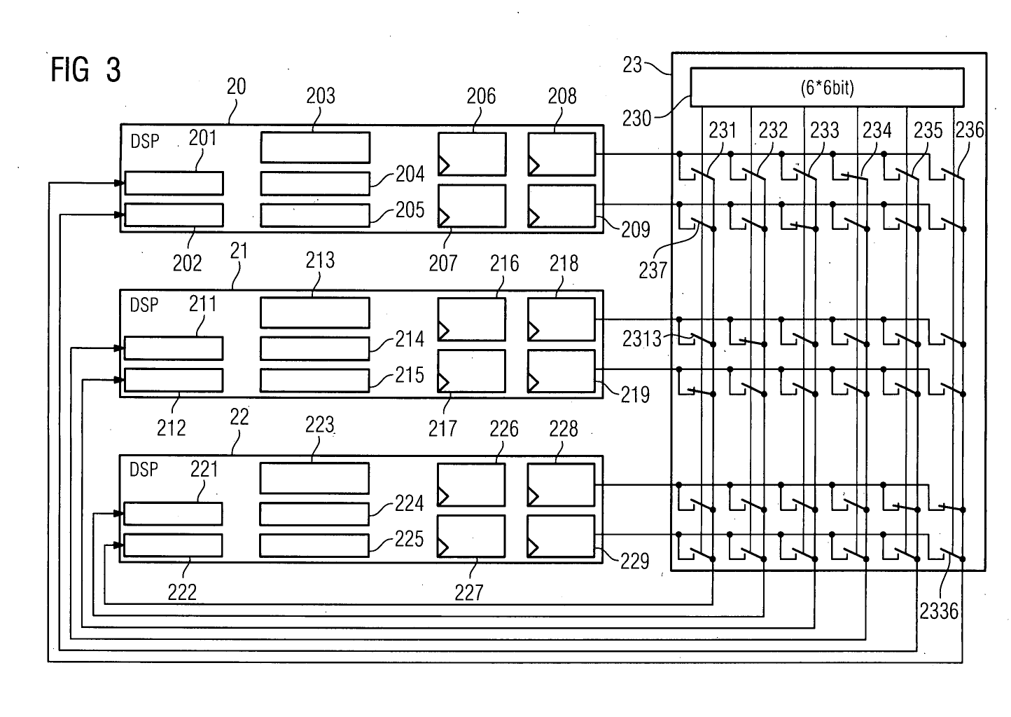

According to the present invention, provision is thus made, as shown in FIG. 3, to connect a number of processors and/or DSPs 20, 21 and 22 to a switching network 23, without a memory being necessary for the communication of the individual processors. In the present example, each of the three processors has two input ports 201, 202; 211, 212; 221, 222 in each instance. Each of the processors 20, 21, 22 also has a memory 203, 213, 223 as well as a control unit 204, 214, 224 and an arithmetic logic unit 205, 215, 225. Furthermore, in the present case, two internal registers 206, 207; 216, 217; 226, 227 and two output registers 208, 209; 218, 219; 228, 229 are provided in each processor 20, 21, 22. Each of the control units 204, 214, 224 is used to implement a respective process controller in the processor. To this end, said process controller accesses the processor-internal memory 203, 213, 223 in order to load commands and accesses the input ports 201, 202; 211, 212; 221, 222 or the internal registers 206, 207; 216, 217; 226, 227 for the data for instance. If necessary, calculations are carried out in the respective arithmetic logic unit 205, 215, 225 in order to execute these commands on the basis of the data available. The results of the data processing are stored in each processor 20, 21, 22 in the respective internal output registers 208, 209; 218, 219; 228, 229.

To now make the data stored in the output registers 208, 209; 218, 219; 228, 229 available for another processor in each instance, the output registers are as requested directly connected to the switching network 23 and individually connected to the input ports 201, 202; 211, 212; 221, 222. As the present example essentially has 6×6 possibilities of connecting the output register to the input ports, the switching network 23 has 36 switches 231 to 2336. These switches are arranged in the manner of a matrix. The output register 208 of the processor 20 is connected to the switches 231, 232, 233, 234, 235 and 236 for instance. In the vertical direction of the matrix, the switches 231, 237, 2313, 2319, 2325 and 2331 are connected to the input port 222 of the processor 22 for instance. The remaining output registers and input ports are similarly interconnected. Each of the switches 231 to 2336 is controlled by an internal configuration memory 230 of the switching network 23. In the present example, the switching network is encoded with 36 bits. This encoding is to be stored in the memory 230 on system start-up and can be changed if necessary.

The communication between the processors is now carried out by way of these switched connections. In the present example, the switches 234 and 239 are interconnected inter alia, so that a connection between the output register 208 of the processor 20 and the input port 211 of the processor 21 results on the one hand and a connection between the output register 209 of the processor 20 and the input port 212 of the processor 21 results on the other hand. The output ports are thus to be seen as registers and are described directly with the embodiment of a computing step. The result of the computing step is thus directly available to the processor which is arranged downstream thereof. A special memory access with addressing and memory control is not necessary. Energy can then be saved during the communication between the two processors.

Essentially the signal lines shown in the above example can also be buses comprising several individual lines (e.g. for parallel transmission of 16-bit data words).

In accordance with the invention, an optimized processor system is thus provided, which consists of several signal processing units with a direct, low-current communication possibility. If a specialized command record is used with the signal processing units and/or processors, additional current can be saved.

1.-6. (canceled)

7. A hearing device, comprising:
a processor system, comprising:
a first processor comprises an output,
a second processor comprises an input, and
a switching facility with which the output of the first processor is selectively directly connected to the input of the second processor,
wherein the processor system provides signal processing of an input signal.

8. The hearing device as claimed in claim 7,
wherein each of the processors comprise a plurality of inputs and a plurality of outputs, and
wherein for each input-output combination the switching facility includes a separate switch for selectively directly connecting each input-output combination.

9. The hearing device as claimed in claim 8, wherein the switching facility includes a configuration memory that stores switching information used to control the switch.

10. A processor system for a hearing apparatus, comprising:
a first processor comprises an output;
a second processor comprises an input; and
a switching facility with which the output of the first processor is selectively directly connected to the input of the second processor.

11. The processor system as claimed in claim 10,
wherein each of the processors comprise a plurality of inputs and a plurality of outputs, and
wherein for each input-output combination the switching facility includes a separate switch for selectively directly connecting each input-output combination.

12. The processor system as claimed in claim 11, wherein the switching facility includes a configuration memory that stores switching information used to control the switch.

13. The processor system as claimed in claim 11, wherein the switching facility is designed in the manner of a matrix, and a switch being arranged at each node point in each instance.

14. The processor system as claimed in claim 13, wherein the switching facility includes a configuration memory that stores switching information used to control the switch.

15. The processor system as claimed in claim 10, wherein the output of the first processor includes an output register, and wherein the input of the second processor is formed without a register.

16. The processor system as claimed in claim 10, wherein processor system is included in a hearing device for signal processing of an input.
